(19) United States
(12) Patent Application Publication
(10) Pub. No.: US 2024/0178392 A1
(43) Pub. Date: May 30, 2024

(54) PROTEINACEOUS ELECTRODE BINDER

(71) Applicant: Technion Research & Development Foundation Limited, Haifa (IL)

(72) Inventors: Yair EIN-ELI, Haifa (IL); Nadav AMDURSKY, Haifa (IL)

(73) Assignee: Technion Research & Development Foundation Limited, Haifa (IL)

(21) Appl. No.: 18/522,518

(22) Filed: Nov. 29, 2023

Related U.S. Application Data
(60) Provisional application No. 63/428,749, filed on Nov. 30, 2022.

(51) Int. Cl. H01M 4/60; H01M 4/04

(52) U.S. Cl. CPC H01M 4/602; H01M 4/0471

(57) ABSTRACT

The present invention discloses a slurry for electrode preparation, relevant to the field of electrode fabrication for various applications, which consists of an active material, a conductive additive, and a binder composition that includes a proteinaceous substance that may comprise amino acids, peptides, and/or proteins. The instantly disclosed slurry is useful in electrode fabrication, especially in the context of Li batteries. The process for preparing the electrode includes applying the slurry to a current collector and thermally treating the slurry, ensuring a durable and reliable electrode.

### RELATED APPLICATION(S)

This application claims the benefit of priority under 35 USC § 119(e) of U.S. Provisional Patent Application No. 63/428,749 filed on Nov. 30, 2022, the contents of which are all incorporated by reference as if fully set forth herein in their entirety.

### FIELD AND BACKGROUND OF THE INVENTION

The present invention, in some embodiments thereof, relates to electrochemistry, and more particularly, but not exclusively, to an electrode binding material based on proteins.

Li-ion battery (LIB) is the most widely used energy storage device for portable consumer electronic devices, electric vehicles, and electric grids. Additionally, LIBs have become emerging devices to store renewable energy (i.e., wind, solar, geothermal). Due to the widespread use of LIBs, efforts are made to increase the battery capacity, mostly by incorporating elemental silicon (Si) utilizing it as an anode material either in part as a carbon composite form or as 100% silicon.

The components of a lithium-ion battery typically include an anode (a current collector, an anode layer containing anode active material, which serve to store lithium therein, conductive additive, and a binder), an electrolyte and a porous separator, and a cathode (a current collector, a cathode layer containing a cathode active material which serves to store lithium therein, a conductive additive, and a binder). The electrolyte is in ionic contact with both the anode active material and the cathode active material. If the electrolyte is a solid-state electrolyte, no porous separator is required. The binder of the anode layer binds the anode active material (e.g., graphite or Si particles) and the conductive filler (e.g., carbon black particles or carbon nanotubes) to form an anode layer having structural integrity, and forms the anode layer. The cathode also uses a binder resin to bond the cathode active material and the conductive additive particles together to form a cathode active layer with structural integrity. The resin binder also serves to bond such a cathode active layer to the cathode current collector.

Binder materials are responsible for holding together the active material particles on or within the electrode to maintain a strong connection between the electrode and the contacts. These binding materials are normally inert and have an important role in the manufacturability of the battery. Binders must be flexible, insoluble in the electrolyte, chemically and electrochemically stable and easy to apply to the electrodes. Binders for the positive cathode also need to be resistant to oxidation. A common binder material for the cathode is polyvinylidene fluoride, whereas a common anodic binder material is styrene-butadiene copolymer. As electrode materials advance, binder materials that improve the performance of the new electrode materials are also required.

Conventional binders such as polyvinylidene fluoride (PVDF), styrene butadiene rubber (SBR), and others, cannot be used in Si-based electrodes, as they do not bind well with silicon or lithium silicates and do not have the ability to expand and/or contract to allow for volume changes without loss in contact (e.g., electrical conductivity contact) between electrode material particles (e.g., electrochemically active material particles, electrically conductive filer particles, etc.) and a current collector. Conventional binders (e.g., PVDF, SBR) used in LIBs attach to silicon and/or lithium silicates via weak van der Waals forces, and thus fail to accommodate large changes in spacing between electrode material particles during charging and discharging. During repeated charging/discharging, conventional binders become inefficient in holding the electrode material particles together and maintaining good electrical conductivity within the electrode, thereby resulting in capacity fading and increase in resistance.

Generally, relatively large amounts of conventional binder material are required for manufacturing of electrodes (e.g., anodes and cathodes), owing to a lack of binding strength of conventional binders (e.g., PVDF, SBR). Typically, a conventional binder is used in an amount of 5-15 wt. % of the weight of the slurry (ink) for manufacturing electrodes. As binders do not contribute directly to the energy density of LIBs, decreasing the binder amount would allow the use of a higher amount of electrochemically active material, thus leading to an increase in the energy density of LIB. Excessive binder content in the electrode can also lead to a decrease in ionic conductivity of the electrode due to ion-blocking property of the ionic insulating binder. Further, a decrease in binder content could lead to a decrease in LIBs' raw material and processing cost. Thus, there is an ongoing need for the development of binder material compositions for LIBs.

In addition to carbon-based or graphite-based anode materials, other inorganic materials evaluated for potential anode applications include metal oxides, metal nitrides, metal sulfides, and the like, as well as various metals, metal alloys, which can accept or react with lithium atoms/ions, and intermetallic compounds. Among these materials, lithium alloys having a compositional formula of Li a A (A is a metal or semiconductor element such as Al and Si and “a” satisfies 0<a≤5) have a high theoretical capacity (e.g., Li 4 Si (3,829 mAh/g), Li 4.4 Si (4,200 mAh/g), Li 4.4 Ge (1,623 mAh/g), Li 4.4 Sn (993 mAh/g), Li 3 Cd (715 mAh/g), Li 3 Sb (660 mAh/g), Li 4.4 Pb (569 mAh/g), LiZn (410 mAh/g), and Li 3 Bi (385 mAh/g). However, in an anode made of such a high-capacity anode active material, severe grinding (crushing of alloy particles) and separation of active material particles from the resin binder occur during charge and discharge cycles. This is due to the severe expansion and contraction of the anode active material particles caused by intercalation and extra-particle extraction of lithium ions. Expansion and contraction of the active material particles, and thus crushing and separation from the resin binder, leads to a loss of contact between the active material particles and the conductive additive and a loss of contact between the anode active material and the anode current collector. These side effects result in a significant shortening of the charge and discharge cycle life.

The pulverization of electrode structure during repeated volume expansion-shrinkage during LIB cycling remains a critical drawback to silicon-based LIBs. The use of polymeric binders to diminish the volume expansion-shrinkage drastic and detrimental effects aiming at primarily maintaining the electrode integrity is thoroughly studied. Linear polymeric binders with a certain ability of silicon surface binding such as sodium carboxymethyl cellulose (Na-CMC), poly(acrylic acid), alginate, and xanthan gum have been introduced. Beyond these linear configurations, new concepts such as 3D network formation, self-healing, and molecular machine principles have been introduced.

Despite that, the challenges regarding the repeated volume changes observed in silicon anode materials, have not been fully addressed. The art lacks binder materials and other approaches that can effectively reduce or eliminate the expansion/contraction problems of the anode active material of lithium-ion batteries.

Thus far, many different binders applied for Si anodes in LIBs have been introduced, consisting mainly from cross-linked polymers (synthetic or bio-derived) either in linear or branched configurations, such as alginate, poly(acrylic acid), polymer adhesives, cyclodextrin-containing polymers, polysaccharides, and xanthan gum. The aim of such studies is to show improved conductivity, low interfacial impedance, mechanical adhesion and robust-ness, and preferably self-healing, allowing increased capacity retention, enhanced rate capability, higher energy density, and longer cycle life.

Engineering new biohybrid materials with tunable functional properties is of increasing interest. Such biohybrid materials are based on the use of biopolymers fabricated by natural macromolecular proteins/polysaccharides. While biohybrid materials are mainly used in medicine-related applications, there is a growing trend in using them in other areas. Here, we are using protein-based biopolymers in Li-ion batteries (LIBs) as binders to stabilize powdered Si anodes.

Hence, there is an urgent and ongoing need for new protective or binder materials in which lithium-ion batteries can exhibit long cycle life. There is also a need for a method for easily or easily preparing such materials in bulk. Accordingly, it is an object of the present invention to meet this need and to solve the problems associated with rapid capacity decay of lithium batteries containing high-capacity anode active materials.

### SUMMARY OF THE INVENTION

The present disclosure provides a protein-based electrode binder for electrodes used, e.g., in lithium batteries. Such binder composition can overcome the rapid capacity decay problems commonly associated with lithium-ion batteries featuring high-capacity anode active materials such as Si, Sn, and SnO₂.

A solution to the problems associated with silicon composite electrodes in LIBs is disclosed here, by introducing thermally processes proteinaceous substances as binders in the Si composite electrode. Fully denaturized proteins lose their secondary, tertiary and quaternary structures and become mostly a random coil or unfolded state. This means that the protein's secondary, tertiary, and quaternary structures are disrupted, and the polypeptide chain loses its defined shape. The protein's primary structure, the sequence of amino acids, remains intact, but the overall three-dimensional structure is lost. However, such structures, even after a full denaturation, breaking the H-bonds, hold structural water which are detrimental to any LIB operation. For that reason, the initial intention was to remove traces of water from the structure, and during the thermal treatment (heating) of the composite electrode it was surprisingly found that the thermally processed proteinaceous substances exhibited superior binder performance.

The present disclosure provides a binder composition designed not only for batteries but for the preparation of any electrode comprising powders. The electrode can be used in batteries, super capacitors, fuel cells and more. It is also intended for use in batteries, and more specifically, in lithium-ion batteries, and more uniquely for anodes for lithium-ion batteries based on silicon as the active ingredient (combining carbon or carbon and graphite).

According to an aspect of some embodiments of the present invention, there is provided a slurry (ink) for an electrode, which includes an active material, a conductive additive, and a binder composition, wherein the binder composition comprises a proteinaceous substance. In addition, the slurry includes a medium/carrier/solvent.

In some embodiments, the binder composition comprises at least one amino acid, and/or at least one peptide, and/or at least one protein.

In some embodiments, the proteinaceous substance is at least partially denatured.

In some embodiments, the proteinaceous substance is cross-linked.

In some embodiments, the proteinaceous substance is characterized by at least one of:
commercial availability in large amounts;
low cost;
non-toxicity;
environmentally friendly manufacturing process;
water solubility greater than 10 mg/ml; and
hydropathy index greater than 0.5.

In some embodiments, the peptide and/or said protein is chemically modified, and in some embodiments, the chemical modification is selected from the group consisting of cross-linking, sulfonation, and hydrolysis. In some embodiments, the protein is denatured.

In some embodiments, the binder composition includes a reagent, or a solvent selected from the group consisting of trifluoroethanol, trifluoroacetic acid, ethylenediamine and any combination thereof.

In some embodiments, the amount of said the material in the slurry ranges 50-90 wt. % of the slurry; the amount of the conductive additive ranges 10-30 wt. % of the slurry; and the amount of the binder composition ranges 5-20 wt. % of the slurry.

In some embodiments, the amount of the proteinaceous substance in the binder composition ranges 1-15 wt. % of the binder composition.

In some embodiments, the active material is selected from the group consisting of carbonaceous materials, alloys based on Si, Sn, Al, Ga, Ge, Pb, and Sb, metal oxides, metal chalcogenides, lithium cobalt oxide (LiCoO₂, LCO), lithium manganese oxides (LiMnO₂ and LiMn₂O₄, LMO), lithium iron phosphate (LiFePO₄, LFP), lithium nickel cobalt oxide (LiNi1-xCoxO₂ (0.2≤x≤0.5), LNCO), lithium nickel manganese cobalt oxide (LiNi1/3Co1/3Mn1/3O₂, LNCMO), and lithium nickel manganese oxide (LiNi_{0.5}Mn_{0.5}O₂, LNMO).

In some embodiments, the conductive additive is selected from the group consisting of carbon black, Super P, graphite (e.g., SFG6L), acetylene black, carbon nanofibers, and carbon nanotubes.

According to an aspect of some embodiments of the present invention, there is provided an electrode that include a current collector, and a layer of a thermally treated slurry applied on a surface of the current collector, wherein the slurry (ink) is as provided herein.

In some embodiments, the layer of the thermally treated slurry comprises the active material, the conductive additive, and a binder in the form of a residue of the binder composition (the residue is the result of the thermal treatment/processing of the binder composition).

According to an aspect of some embodiments of the present invention, there is provided a process of preparing the electrode of the present invention. The process is effected by providing the slurry presented herein, applying the slurry over the surface of the current collector, heating the slurry that is applied on the surface to a temperature of more than 120° C., thereby obtaining the layer of the thermally treated slurry on the surface.

In some embodiments, the heating is effected at a temperature that ranges 120-300° C., or 200-250° C.

In some embodiments, the applying is effected by doctor blade.

According to yet another aspect of some embodiments of the present invention, there is provided an electrode that includes:
a current collector; and
a layer of a slurry applied on a surface of the current collector, wherein the slurry includes:
an active material;
a conductive additive; and
a binder composition,
wherein:
the binder composition includes a proteinaceous substance, the proteinaceous substance includes at least one amino acid, and/or at least one peptide, and/or at least one protein;
the proteinaceous substance is at least partially denatured; and
the proteinaceous substance is cross-linked.

According to an aspect of some embodiments of the present invention, there is provided an electrode that includes a current collector and a layer that comprises an active material, a conductive additive and a binder composition applied thereon,
wherein the binder composition includes a proteinaceous substance, and the proteinaceous substance includes at least one amino acid, and/or at least one peptide, and/or at least one protein.

According to an aspect of some embodiments of the present invention, there is provided a battery which includes at least one of any electrode according to some embodiments of the present invention, wherein the electrode includes the proteinaceous binder composition provided herein, namely a binder composition that includes a proteinaceous substance.

Following is a non-exclusive list including some examples of embodiments of the invention. The invention also includes embodiments which include fewer than all the features in an example and embodiments using features from multiple examples, also if not expressly listed below.

Example 1. A slurry for an electrode, comprising:
an active material;
a conductive additive; and
a binder composition,
wherein the binder composition comprises a proteinaceous substance, the proteinaceous substance comprises at least one amino acid, and/or at least one peptide, and/or at least one protein.

Example 2. The slurry of example 1, wherein the proteinaceous substance is characterized by at least one of:
commercial availability in large amounts;
low cost;
non-toxicity;
environmentally friendly manufacturing process;
water solubility greater than 10 mg/ml; and
hydropathy index greater than 0.5.

Example 3. The slurry of example 1, wherein the peptide and/or the protein is chemically modified, the chemical modification is selected from the group consisting of cross-linking, sulfonation, and hydrolysis.

Example 4. The slurry of any one of examples 1-3, wherein the protein is denatured.

Example 5. The slurry of any one of examples 1-4, wherein the binder composition comprises a reagent selected from the group consisting of trifluoroethanol, trifluoroacetic acid, ethylenediamine and any combination thereof.

Example 6. The slurry of any one of examples 1-5, wherein:
an amount of the active material ranges 50-95 wt. % of the slurry;
an amount of the conductive additive ranges 5-30 wt. % of the slurry; and
an amount of the binder composition ranges 5-20 wt. % of the slurry.

Example 7. The slurry of any one of examples 1-6, wherein the amount of the proteinaceous substance in the binder composition ranges 1-15 wt. % of the binder composition.

Example 8. An electrode comprising:
a current collector; and
a thermally treated layer of the slurry of any one of examples 1-7 applied on a surface of the current collector.

Example 9. A battery comprising the electrode of example 8

Example 10. A process of preparing the electrode of example 8, comprising:
applying the slurry of any one of examples 1-7 on the surface;
heating the slurry to a temperature of more than 120° C., thereby obtaining the thermally treated layer.

Example 11. The process of example 10, wherein the temperature ranges 120-300° C.

Example 12. The process of example 11, wherein the temperature ranges 200-250° C.

### DESCRIPTION OF EMBODIMENTS OF THE INVENTION

The present invention, in some embodiments thereof, relates to electrochemistry, and more particularly, but not exclusively, to an electrode binding material based on proteins.

Before explaining at least one embodiment of the invention in detail, it is to be understood that the invention is not necessarily limited in its application to the details set forth in the following description or exemplified by the Examples. The disclosure is meant to encompass other embodiments or of being practiced or carried out in various ways.

As discussed hereinabove, LIBs with Si anodes were introduced to the market more than three decades ago as rechargeable energy storage devices, and although LIBs offer high energy density and have reached a high level of maturity, there are still many technological challenges to meet established user habits and increasing demands. Currently the most promising anode material for LIBs is Si, which exhibits an outstanding theoretical capacity of 4200 mAh g-1, but suffers from stability and lifetime limitations caused by dramatic volume changes (up to 400%) during cycling. The volume expansion during lithiation causes a disruption of inter-facial layers and their subsequent recreation, resulting in reduced coulombic efficiency, large initial capacity loss, insufficient cycle life, and unsafe performance. In general, the amount of Li ions consumed due to protective solid electrolyte interphase (SEI) film build-up, directly affects the reversible capacity obtained upon cycling. For example, carbon-based anodes consume about 10-15% of their original capacity by the SEI formation. These numbers are even higher for Si-based anodes, where the losses range from 30-50%, occurring in almost each battery cycle, due to repeated mechanical stresses, depending on cell configuration.

The present inventors contemplated using protein-based biopolymers in Li-ion batteries (LIBs) as binders to stabilize powdered Si anodes. The interest in alloying-type Si anodes arises due to its abundance in nature, low cost, and high theoretical capacity (4200 mAh-g-1), which is more than one order of magnitude higher than that of graphite anodes. Previous attempts to apply polymers as binders for LIBs suffered from electrochemical (EC) instability (gases evaluation upon battery cycling) and safety issues. Hence, many of the suggested polymeric binders were halogenated compounds that are considered very toxic. Conversely, biopolymers are eco-friendly materials, which may be safely disposed.

While attempting to tackle all these critical issues, the present inventors contemplated the development of an advanced binder material that serves as a flexible, robust, and functional matrix, capable of accommodating large mechanical stresses at the surface of active electrode material species. Thus, the adhesion and elasticity characteristics of a potential binder are of critical importance to achieve stable performance and to overcome numerous challenges, namely cracking, fracture, electrical disconnection, and physical delamination occurring upon extreme volume changes during battery cycling. Chemical inertness to electrolyte components, insolubility in the electrolyte at operation temperatures, and electrochemical stability over the whole range of LIB's operation potentials are also necessary properties. Moreover, the presence of a binder in the electrode composition should not increase the impedance at the solid-electrolyte interphase.

Initially, using protein-based binder materials seem challenging since proteins retain structural water, proteins are not very stable, they are amphiphilic and not simply water/organic soluble, and most importantly, proteins are not optimal for ionic conductivity. Therefore, it was a serendipitous finding when the present inventors have witnessed the superb behavior of a protein-based material as a binder in Si anodes, and especially after thermal processing the material, which was conducted in an attempt to remove structural water.

The main advantage of proteins as electrode ink slurry binders, as provided herein, is to maintain the structure of the powdered Si anode throughout the repeated volume expansion and shrinkage during lithiation cycling. It was shown that protein-based binders substantially improve specific capacity and cycle life of LIBs.

The present invention was also driven by considerations of cost-effectiveness and environmental impact. To address these motivations, the inventors have showcased the application of widely available proteins as binders in electrode ink slurries. By utilizing sustainable sources of proteins, which are abundant and cheap, the invention maintains the advantageous properties associated with the use of proteins as binders in lithium-ion batteries (LIBs). This approach ensures both economic viability and eco-friendliness in the production of LIBs, aligning with the dual goals of cost-effectiveness and environmental sustainability.

The present invention also introduces a novel technology that integrates the heat-drying phase of composite anode manufacturing with the concluding phase of protein-based binder preparation. This integration leads to a notable enhancement in the performance of Si anodes, an increase in Si content within the composite anode, and cost savings in production. Anticipated outcomes from the present invention include advancements in the widespread application of promising alloying and conversion-type anode materials, specifically Si and Sn.

As proteins are known to undergo some degree of structural deformation following thermal denaturation, our suggestion of thermal processing the protein-based materials is counter-intuitive, and never thought of before. The innovative gist of the present invention looks at proteins and their constituents from materials point of view rather than for their biological activities.

The main merit that differentiates proteins from any other synthetic polymer or other bio-derived polymers (such as a polysaccharides-based polymer) is their structure. Proteins have levels of structural hierarchy, going from their primary amino acid sequence, a secondary configuration of folding to (usually) an alpha-helix or a beta-sheet, a tertiary 3D structure of the entire protein consists of the different secondary motifs, and in some cases also a quaternary structure of the folding of several identical proteins. It is also well-known that peptides, as short as dipeptides or even single amino acids, can self-assemble to form diverse supramolecular structures. Another important property of peptides and proteins compared to other biopolymers is the diversity of their building blocks, i.e., amino acids, consists of the twenty naturally occurring amino acids, and many more unnatural.

While attempting to investigate the possibility of using proteins as binder material for silicon-composite electrodes in LIBs, the present inventors have studied the use of a cross-linked protein film, essentially as disclosed in WO 2021/084538, to one of the present inventors. WO 2021/084538 discloses a protein based highly stretchable compositions with ionic conductivity, which can be applied or formed in any shape. Specifically, the composition provided in WO 2021/084538 includes an at least partially denatured protein and one or more cross-linker agents, wherein the composition is characterized by a conductivity in the range of 0.1 mS cm⁻¹ to 1.5 mS cm⁻¹.

In an attempt to reduce the amount of structural water still held by the protein-based composition (WO 2021/084538), by heating the binder-loaded electrodes in an oven, it was surprisingly found that the thermally processed protein film afforded by the composition exhibited superior binder performance in the context of a LIB anode.

While reducing the present invention to practice, the present inventors have demonstrated that a thermally processed cross-linked protein-based film can be effectively used as a binder of Si composite electrodes. The initial surprising and promising results, show that the electrochemical response and behavior of Si anode in the cycled cell (against Li-metal) depends on the thermal processing temperature of the protein-coated electrode. Increasing the thermal processing temperature leads to a more stable electrode cycling, achieving extreme reversible capacities.

The present inventors have found that using cross-linked protein-based polymers as binders in Si anodes outperformed other synthetic polymers; however, the most surprising result was that thermal processing (heating) the proteinaceous binder resulted in a notable improvement of the Si anode and that there is an optimal drying/baking temperature for gaining an optimal cell performance. Importantly, it was found that while proteins exhibited this superior behavior following thermal processing, other synthetic polymers did not.

In general, the ideal properties for a binder material in LiB electrodes are met by the thermally treated proteinaceous substance provided herein, which include: 1) stability in high voltages, up to 8 volts; 2) inert to Li, meaning it does not contain strong oxidizing agents that can oxidize lithium; 3) allow diffusion of Li ions therethrough, meaning it should be an ionic conductor; 4) binder should co-expand and contract with the Si, meaning keeping the silicon particles intact both in the Si expansion and shrinkage, or at least will not allow the debris of the Si to diffuse away; 5) binder should exhibit the ability to be wetted by the non-aqueous, polar, and organic electrolyte.

A Slurry (Ink) for Electrodes

In the context of the present invention and electrode manufacturing, the term “slurry” refers to a semi-liquid mixture or suspension of solid particles dispersed in a liquid or gel-like medium. This mixture plays a role in the fabrication of electrodes for various devices, including electrodes for batteries. Once a slurry is prepared, it is coated onto a current collector, typically made of metal, and then undergoes a drying process to remove the solvent, leaving behind a solid electrode with the active material adhered to the current collector. The drying step is typically effected at temperatures less than 100° C. in order not to weaken the binder material, which is typically an organic polymer.

A typical composition of a Lithium-ion Battery (LiB) electrode slurry includes several key components that contribute to the formation of an effective electrode. The electrode slurry is a mixture of active materials, conductive additives, binders, solvents, and other optional additives. A breakdown of the typical components include:

Active material: for the anode (negative electrode), the common anode materials include silicon, graphite, or other materials capable of intercalating lithium ions during the charging and discharging processes; for the cathode (positive electrode), the common materials include lithium cobalt oxide (LiCoO₂), lithium manganese oxide (LiMn₂O₄), lithium iron phosphate (LiFePO₄), and others;

Conductive additives: to enhance electrical conductivity, create a conductive network within the electrode, and improve the overall performance of the electrode, carbon additives such as carbon black or carbon nanotubes are often included;

Binder: a binder is used to hold the active materials and conductive additives intimately together, providing structural integrity to the electrode. Most widely used binders before the present invention include polyvinylidene fluoride (PVDF) or carboxymethyl cellulose (CMC); and

Solvents: a slurry is typically prepared using nonaqueous solvents such as, without limitation, N-methyl-2-pyrrolidone (NMP) and/or dimethyl carbonate (DMC), or a mixture of solvents. These solvents help create a homogenous mixture and are later evaporated during the electrode coating process.

One of the objectives of the present invention is to provide an alternative to the binder component, particularly for electrodes that experience volume changes, as typically exhibited during Li-ion intercalation and deintercalation. Thus, according to an aspect of some embodiments of the present invention, there is provided a slurry for an electrode, which includes an active material, a conductive additive, and a binder composition, wherein said binder composition comprises a proteinaceous substance.

According to some embodiments of the present invention, the slurry comprises:
active material in an amount that ranges 50-95 wt. % of the slurry;
conductive additive in an amount that ranges 3-30 wt. % of the slurry; and
binder composition in an amount that ranges 2-25 wt. % of the slurry.

According to another aspect of some embodiments of the present invention, there is provided a binder composition that includes a proteinaceous substance, as defined, described and exemplified hereinbelow.

The binder composition includes proteinaceous substance and one or more solvents that are expected to substantially evaporate or otherwise be eliminated from the electrode upon effecting a thermal treatment, as discussed hereinbelow. The solvents are selected capable of dissolving/suspending the slurry's ingredients and spreading the slurry uniformly on the surface of the current collector of the electrode. Non-limiting examples of organic solvents that can be used in the slurry provided herein include trifluoroethanol (TFE) ethylenediamine (EDA), N-methyl-2-pyrrolidone (NMP), dimethyl carbonate (DMC), and any mixture thereof.

According to some embodiments of the present invention, the amount/concentration of the proteinaceous substance in the binder composition ranges 1-15 wt. %, 1-10 wt. %, or 1-5 wt. % of the binder composition prior to its exposure of the slurry to the thermal treatment. According to some embodiments, the proteinaceous substance content in the slurry may range from 0.1 wt. % to 50 wt. % of the slurry.

It is an objective of the present invention to provide protein-based electrode binders from raw natural resources, which are biodegradable and readily available. Since some embodiments of the present invention relate to LIBs, availability and sustainability of the proteinaceous binder compositions are also considered, particularly when considering the demand for large industrial quantities of the raw natural material. Accordingly, contemplated are bio-derived proteinaceous substances that can be extracted from natural sources in industrial scales without causing depletion of natural resources, mainly targeting proteins from waste sources. Binder compositions made from such proteinaceous substances are environmentally friendly as well as promote a circular use of raw biomass from what can be considered a sustainable source. Indeed, such protein-based biopolymers have been the subject of many studies toward applications in adhesives, sealants, superabsorbents, food packaging, as well as in biomedical applications. An added advantage of using proteins from waste sources is the low cost thereof.

Embodiments of the present invention encompass proteinaceous substances composed of single amino acids, peptides having different secondary structures, and whole proteins. The term “proteinaceous substance”, as used in the context of the present invention, refer to all types of amino-acid based/containing materials, including single amino-acids, short peptides (2-100 aa residues long), proteins (longer than 20 aa), modified proteins and peptides, protein derivatives, and super-structures comprising the same, for the formulation of the binder. Any partially and fully denaturized protein of any structure and type is encompassed within the scope of the present invention.

Proteins are biomolecules composed of amino acid chains, typically playing crucial roles in various biological functions, serving as structural components, enzymes, antibodies, and more. In some embodiments of the present invention, the proteinaceous substance may include naturally occurring proteins, namely proteins that exist in living organisms. The scope of the invention encompasses naturally occurring proteins that have undergone chemical modification, either during harvesting/manufacturing or purposely modified to improve their properties for the intended use, specifically as a constituent in the binder composition for electrodes provided herein. Using naturally occurring proteins is consistent with one of the objectives of the present invention, which is to provide a binder composition for battery production that is cheap, non-toxic and environmentally friendly in terms of its sourcing and use.

In some embodiments of the present invention, the proteinaceous substance may include structural proteins (e.g., collagen, gelatin (hydrolyzed collagen), keratin, actin, tubulin, myosin, fibrin, elastin, laminin, tropomyosin, titin, nexin, plectin, desmin, spectrin, and zyxin), storage proteins (e.g., albumin, casein, ferritin, globulin, gluten, legumin, ovalbumin, prolamin, and zein), transport proteins (e.g., hemoglobin, albumin, ferritin, transferrin, hemocyanin, and aquaporin), enzymes, proteasomes, and any form of the above as conjugated proteins (e.g., glycoproteins such as mucin, lipoproteins, and metalloproteins).

In some preferred embodiments, the protein is selected from the group consisting of commercially available and low-cost proteins, such as, for non-limiting examples, bovine serum albumin (BSA), mucin, horseradish peroxidase (HRP), lactoferrin, albumin (from egg whites or milk), casein, soy protein, wheat gluten, corn gluten, legume (peas, chickpeas, lentils) proteins, canola proteins, and gelatin.

Defining commercial availability of a protein can be challenging due to fluctuations in production technology, demand and supply. For example, at the time of the invention, the global annual production of soy protein was more than 50 million metric tons, collagen more than 1 million metric tons annually, and 100,000 metric tons of egg protein were produced annually around the globe. As a selection criterion for a protein suitable in the context of the binder composition provided herein, the proteinaceous substance is characterized by a global annual production of at least 100,000 metric tons per year.

Defining cost-effectiveness of a protein can be challenging due to fluctuations in market prices (demand and supply) and variations in production methods. However, in general, low-cost proteins are typically those that can be produced in large quantities with minimal processing requirements. Based on current market trends, proteins with a cost of less than $5 per kilogram are considered low-cost. These proteins are often derived from plant sources, such as soy, corn, and wheat, and are readily available in commercial quantities. For example, soy protein isolate costs $2-3 per kilogram, corn gluten meal cost $1-2 per kilogram, wheat gluten costs $3-4 per kilogram, and pea protein costs $3-5 per kilogram. Animal-based proteins are typically more expensive; some examples of animal-based industrially used proteins and their approximate costs at the time of the present invention, include collagen that costs $2-4 USD/Kg, gelatin that costs $5-8 USD/Kg, whey protein that costs $10-15/Kg, casein that costs $15-20/Kg, and egg protein that costs $20-25/Kg. As a selection criterion, the protein used as the proteinaceous substance in the binder composition provided herein, is characterized by a market price of less than $30 USD per kilogram.

Non-toxicity of proteins, particularly of proteins being mass-produced for the food industry, is typically given characteristics. Quantitatively definition of non-toxicity in the context of proteins involves establishing a threshold below which a protein is considered non-toxic. This threshold is typically expressed in units of milligrams of protein per kilogram of body weight (mg/kg BW) per day. The specific threshold value may vary depending on the specific protein, the route of exposure (e.g., oral, inhalation, dermal), and the sensitivity of the test subject. One commonly used criterion to define non-toxicity is based on the concept of the “no-observed-adverse-effect level” (NOAEL), which is the highest dose of a substance that does not produce any observable adverse effects in a test population. In the context of the proteinaceous substance in the presently provided binder composition, the NOAEL can be used to establish a safe level of intake for human exposure. For instance, the NOAEL for soy protein isolate has been determined to be 1500 mg/kg BW per day. Another approach to quantify non-toxicity is to measure the protein's potential to cause adverse effects in specific target organs or tissues. This can be done using a variety of toxicological assays, such as cell cultures, animal models, and human clinical studies. For example, the potential of a protein to induce kidney toxicity can be assessed by measuring its effects on kidney cells or by observing kidney function in animals exposed to the protein.

In some preferred embodiments, the protein is characterized by high aqueous solubility, and includes, without limitation, serum albumin, lysozyme, ribonuclease A, histone H1, and beta-lactoglobulin. It is noted that the property of water solubility is not absolute and can vary depending on the specific protein and the conditions of the solution, such as pH, ionic strength, and temperature. Proteins with low water solubility typically have concentrations below 10 mg/ml, proteins with moderate water solubility typically have concentrations between 10 and 50 mg/ml, and proteins with high water solubility typically have concentrations above 50 mg/ml. For example, casein and elastin exhibit low water solubility of less than 10 mg/ml, serum albumin and hemoglobin exhibit moderate solubility of 10-50 mg/ml, while lysozyme, ribonuclease A exhibit high solubility with more than 50 mg/ml.

Water solubility selection criteria for suitable proteins may also be based on the hydropathy index of the protein, which is a good calculated predictor for indicating that the protein is most likely to be soluble in water; proteins with higher hydropathy indices have more polar amino acids on their surface, which makes them more likely to interact with water molecules. Hence, in some preferred embodiments, the protein is characterized by a hydropathy index greater than 0.5, or greater than 3.5, indicating a hydrophilic protein, or characterized by a hydropathy index ranging 0.5-3.5, indicate intermediate water solubility. Typically, proteins that are characterized by an hydropathy index smaller than 0.5 are hydrophobic proteins. The hydropathy index may be calculated based on the available protein sequence and possibly structure, using any known algorithm, such as, for example, the Kyte and Doolittle method, the GRAVY method, or the Hopp and Woods method. An example of a protein having a high hydropathy index is corn gluten, indicating that it is the most likely to be soluble in water.

In some preferred embodiments, particularly those than involve the use of non-polar solvents, the protein is characterized by high organic solvent solubility, and include, without limitation, collagen, keratin, membrane proteins, amyloid proteins, and prions. The hydropathy index protein selection criteria can also be used for selecting proteins characterized by high organic solvent solubility.

It is noted herein that aqueous/organic solubility of proteins can be adjusted by adjusting other properties of the binder composition, such as pH, ionic strength, temperature of the solution during preparation of the binder composition. The aqueous/organic solubility of proteins can also be adjusted by chemical modifications, as these are discussed herein.

In some preferred embodiments, the protein is characterized by a relatively low content of hydrophobic amino acid residues, such as, without limitation, plant-based: glutelin, and legumin, and animal-based: seralbumin. It is noted that this protein selection criteria is related to the aqueous/organic solubility characteristic and selection criteria.

In some preferred embodiments, the protein, or at least a portion thereof, is characterized by a helical secondary structure. A helical secondary structure is often referred to as an “alpha helix.” In an alpha helix, the polypeptide chain is coiled in a right-handed manner, forming a spiral structure. This helical conformation is stabilized by hydrogen bonds between the amino acid residues along the chain.

In embodiments wherein the proteinaceous substance comprises proteins, the slurry includes protein that retain their original (natural) primary structure, and essentially their original (natural) secondary structure, or at least the helical sections thereof. A primary structure of a protein is the sequence of amino acids in its polypeptide chain. The secondary structure refers to local structures within a protein and is mainly characterized by patterns of hydrogen bonds between the backbone amide and carbonyl groups, wherein common secondary structures include alpha helices and beta sheets.

In embodiments wherein the proteinaceous substance comprises proteins, the slurry includes reduced proteins. Reduced proteins include proteins that undergone reduction of their disulfide bonds. Disulfide bonds, which form between the sulfur atoms of two cysteine residues, contribute to the stabilization of the tertiary structure of the protein.

In the context of battery electrode materials and slurries, various chemical modifications can be applied to the proteinaceous substance to enhance its performance, such as ionic transport. In embodiments wherein the proteinaceous substance comprises peptides or proteins, the slurry includes chemically modified peptides or proteins. Protein modification which are relevant in the context of the present invention include, without limitation, cross-linking (improve mechanical strength and stability), sulfonation (introduction of sulfonic acid groups (—SO₃H) to increase ionic transport capabilities), partial hydrolysis (as in generating gelatin from collagen), carboxylation (introducing carboxyl groups (—CO₂H) to improve surface tension and enhance its interaction with active materials in the electrode), hydroxylation (adding hydroxyl groups (—OH) to enhance the hydrophilicity, and improve compatibility with certain electrode slurries, phosphonation and phosphorylation (introducing phosphonic acid groups (—PO₃H₂) to a carbon atom or a hydroxyl (—OH) group, respectively, thereby enhancing the ion-conducting properties of the protein), fluorination (improving chemical stability and resistance to degradation during cycling, leading to longer-lasting electrodes), and nitrogen-doping (nitrogen-containing groups can enhance the electronic conductivity of the proteinaceous substance).

According to some embodiments of the present invention, the proteinaceous substance in the binder composition is denatured, at least partially, and preferably it is unfolded with some helical structures maintained. Partial secondary structure can be assessed and determined by methods known in the art, such as Circular Dichroism (CD) Spectroscopy, Fourier Transform Infrared (FTIR) Spectroscopy, Nuclear Magnetic Resonance (NMR) Spectroscopy, and other methods.

Without being bound to any particular theory, it is assumed that disrupting at least the tertiary structure of the protein enhances the ability of the protein chains to form cross-links via functional groups of residues that were not accessible prior to denaturation. Denaturation that is effected by reversibly breaking intramolecular bonds, such as disulfide bonds, frees the relevant side chains to form intermolecular bonds (cross-links). As demonstrated in the Examples section that follows below, the protein (e.g., BAS) is first partially denatured by means of dissolution in trifluoroethanol, and thereafter 2-mercaptoethanol is introduced to the protein as a disulfide bond reducing agent, further breaking the tertiary structure of the protein, and allowing the cysteine residues to form intermolecular disulfide bonds.

In the context of partial denaturation of the protein, it is noted herein that in some embodiments of the present invention, proteins in the binder composition are treated with trifluoroethanol, since this reagent stabilizes alpha helices while destabilizing other secondary and tertiary structure elements, effecting the preferred and advantageous partial denaturation of the protein. As discussed herein, the presence of some secondary structure, particularly alpha helices, promotes the elasticity of the thermally treated layer of the slurry. Trifluoroethanol (TFE) is a solvent that is known to have a unique effect on proteins, particularly on their secondary structure. When a globular protein is contacted with an aqueous solution of trifluoroethanol, the solvent can induce changes in the protein's conformation and stability. The key effects include induction of helical structure, disruption of tertiary structure, solubility enhancement, and reduction of aggregation, all of which improve the performance of the proteinaceous binder composition disclosed herein. While TFE is a unique solvent known for its ability to induce helical structures and other desired effects in proteins, in the context of the present invention, some alternatives to TFE are also contemplated within the scope of the present invention, and include, without limitation:
Hexafluoroisopropanol (HFIP), which is similar to TFE, induces helical structures in proteins. It is often used in studies of protein folding and stability;
Dimethyl Sulfoxide (DMSO), which is a widely used solvent with diverse applications that influence protein structure, and in some cases can be used as an alternative to TFE;
Ethanol, or other alcohols, can have an impact on protein structure, albeit their effects may not be as pronounced or specific as those of TFE;
Guanidine HCl or Urea, which are known chaotropic agents used to denature proteins, disrupting their native structures;
Certain ionic liquids have an impact on protein structure; and
Temperature and pH conditions can also influence protein structure, as well as stabilizing or promoting helical conformations under specific conditions.

According to some embodiments of the present invention, the proteinaceous substance is cross-linked, namely it comprises cross-linked protein molecules, cross-linked protein fragments, and/or cross-linked peptides. In some embodiments, the protein, protein fragments or peptides are denatured and cross-linked. In some embodiments, the proteinaceous substance undergoes chemical modification to enable certain type of cross-linking to be effected. As demonstrated in the Examples section that follows below, the protein (e.g., BAS) is first partially denatured destabilization of some secondary and tertiary structural elements and by reducing the intramolecular disulfide bonds, thereby allowing the BSA strands to undergo intermolecular disulfide bonding, practically effecting cross-linking of the protein strands. In other embodiments, cross-linking is effected by adding a cross-linking agent, such as, without limitation, glutaraldehyde. Alternative cross-linking agents that can be used in the context of some embodiments of the present invention, include, without limitation, formaldehyde, bis(sulfosuccinimidyl) suberate (BS3), dithiobis(succinimidyl propionate) (DSP), 1-ethyl-3-(3-dimethylaminopropyl)carbodiimide (EDC), disuccinimidyl tartrate (DST), ethylene glycol bis(succinimidylsuccinate) (EGS), maleimide cross-linkers (e.g., BMPS), paraformaldehyde, photoactivatable cross-linkers (e.g., Sulfo-SBED), and isocyanate-based cross-linkers (e.g., HDI).

The proteinaceous substance selection criteria, one or more than which may be used to select a suitable protein for use as a proteinaceous substance in the binder composition provided herein, include:
Commercial availability in large amounts and low cost;
Non-toxicity;
Environmentally friendly manufacturing; and
Moderate to high water solubility/hydropathy index.

A proteinaceous substance can include not only intact proteins but also derivatives or fragments obtained through processes like denaturation, cross-linking, chemical modification, hydrolysis or enzymatic digestion.

According to some embodiments of the present invention, the protein constituting the proteinaceous substance in the binder composition provided herein, include, without limitation, bovine serum albumin (BSA), casein, soy protein, zein, egg white albumin, milk albumin, wheat and/or corn gluten, legume (peas, chickpeas, lentils) proteins, canola proteins, collagen and gelatin.

According to some embodiments of the present invention, the binder composition further includes additional binder components and ingredients that are commonly used in the electrode manufacturing industry. Thus, according to some embodiments of the present invention, the binder composition further includes polyvinylidene fluoride (PVDF), a polyacrylic binder, carboxymethyl cellulose (CMC), and/or styrene butadiene rubber (SBR).

### A Process of Electrode Manufacturing

The present invention encompasses both anodes and cathodes for electrochemical cells, batteries, capacitors and the likes, that include a layer of thermally treated slurry comprising the binder composition that includes a proteinaceous substance. The herein-provided proteinaceous binder composition, defined as a binder composition that includes a proteinaceous substance, as defined herein, can be used to adhere to the current collector and at the same time bind together the active material and the conductive additive to the current collector of any cathode and/or anode configuration. Regardless of the type of electrode, its basic constituents are the active material, the conductive additive, and the herein-provided binder composition that includes a proteinaceous substance.

Typically, the difference between anodes and cathodes is the active materials. In the electrode composition, according to some embodiments of the present invention, the amount of active material typically varies between 50 wt. % and 95 wt. %, the conductive additive varies between 3 wt. % and 30 wt. %, and the herein-provided proteinaceous binder composition varies between 2 wt. % and 25 wt. %, where the proportion of 80 wt. %/10 wt. %/10 wt. % for active material, conductive additive, and binder is the most widely used.

The most commonly used active materials for cathodes are metal oxides, such as LiFePO₄, LiCoO₂, or LiMnO₂, as active materials for the cathodes. The selection of the active material is dependent on the specific application, as each one allows for different operational voltage. For the anode, the most common active materials are carbon-based materials, such as graphite and silicon-based materials. The most commonly used active materials for LiB cathodes, which are also preferred in the context of the present invention, include lithium cobalt oxide (LiCoO₂, LCO), lithium manganese oxides (LiMnO₂ and LiMn₂O₄, LMO), lithium iron phosphate (LiFePO₄, LFP), lithium nickel cobalt oxide (LiNi1-xCoxO₂ (0.2≤x≤0.5), LNCO), lithium nickel manganese cobalt oxide (LiNi1/3Co1/3Mn1/3O₂, LNCMO), and lithium nickel manganese oxide (LiNi_{0.5}Mn_{0.5}O₂, LNMO).

According to some embodiments of the present invention, the main active materials for the anode are carbonaceous materials, alloys based on Si, Sn, Al, Ga, Ge, Pb, and Sb, metal oxides, and metal chalcogenides, among others. In one preferred embodiment of the present invention, the active material is silicon (Si).

As the vital part of lithium-ion batteries, conductive additives play important roles in the electrochemical performance of lithium-ion batteries. They construct a conductive percolation network to increase and keep the electronic conductivity of electrode, enabling it charge and discharge faster. In addition, conductive additives absorb and retain electrolyte, allowing intimate contact between the lithium ions and active materials. According to some preferred embodiments, the conductive additive include, without limitation, carbon black, Super P, graphite (e.g., SFG6L), acetylene black, carbon nanofibers, and carbon nanotubes, which all have superior properties such as low weight, high chemical inertia and high specific surface area. They are the ideal conductive additives for lithium-ion batteries.

The slurry provided herein is applied on the current collector (the solid matrix of the electrode) by any commonly used methodology, tools and techniques, such as the doctor blade technique, and thereafter subjected to thermal treatment at the optimal temperature. As known in the art of electrode manufacturing, the temperature at which an ordinary (prior art) slurry is dried during the manufacturing process of electrodes for batteries can vary based on the specific materials used and the desired characteristics of the final electrode. Typically, the drying process involves heating the slurry with the intention to evaporate the solvent, leaving behind a solid layer over the electrode. Commonly, the drying temperature falls within the range of 50° C. to 120° C., and in general, the maximal temperature may be limited to that above which the ordinary binder decomposes or loses some of its desired properties.

As demonstrated in the Examples section that follows below, the slurry having a binder composition component that includes a proteinaceous substance, requires to be thermally treated, namely heated; dried at elevated temperatures; or “baked”. In some embodiments, forming an electrode using the slurry provided herein based on a proteinaceous binder composition, is effected by applying the slurry on a surface of a current collector, and heating the incipient electrode at elevated temperatures above 100° C. to afford all types of electrodes. The various types of slurries comprising a proteinaceous binder composition, are thermally treated in an oven or vacuum oven to a temperature higher than 120° C., or higher than 130° C., higher than 140° C., higher than 150° C., higher than 160° C., higher than 170° C., higher than 180° C., higher than 190° C., or higher than 200° C., or a temperature that ranges 120-300° C., and preferably a temperature that ranges 200-250° C. The duration of the thermal processing step ranges from 5 minutes to 24 hours or longer.

Hence, the phrase “thermally treated” and “thermal treatment”, as used herein, refer to the layer of the slurry, as provided herein, which undergone heating to a temperature higher than 120° C. or higher than 130° C., higher than 140° C., higher than 150° C., higher than 160° C., higher than 170° C., higher than 180° C., higher than 190° C., or higher than 200° C.

### An Electrode, a Cell and a Battery

According to an aspect of some embodiments of the present invention, there is provided an electrode, that includes a residue of the presently provided slurry, which results from the thermal treatment of the slurry during the manufacturing process of the electrode. The term “residue” refers to the solid substance that results from heating the slurry presented herein, as it is “baked” on the surface of the electrode's matrix, e.g., the current collector. In other words, the electrode provided herein includes a current collector, and a thermally treated layer of the slurry provided herein, that has been applied on the surface of the current collector.

Consequently, there is provided an electrochemical cell that includes at least one electrode, as described hereinabove, namely an electrode that includes a binder composition that includes a proteinaceous substance.

Similarly, there is provided a battery that includes at least one cell that includes at least one electrode, as described hereinabove, namely an electrode that includes a binder composition that includes a proteinaceous substance.

Further similarly, there is provided an electric device that is powdered by at least one battery that includes at least one cell that includes at least one electrode, as described hereinabove, namely an electrode that includes a binder composition that includes a proteinaceous substance.

As used herein the term “about” refers to ±10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is totally devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

When applied to an original property, or a desired property, or an afforded property of an object or a composition, the term “substantially maintaining”, as used herein, means that the property has not change by more than 20%, 10% or more than 5% in the processed object or composition.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

It is expected that during the life of a patent maturing from this application many relevant electrodes prepared with proteinaceous binders will be developed and the scope of the phrase “proteinaceous electrode binder” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions, illustrate some embodiments of the invention in a non-limiting fashion.

### Example 1

### Proof of Concept—Crossed-Linked BSA Protein

As a proof of concept, a 70 wt. % Si anode in a Lithium-Ion Battery (LiB) was prepared using 10 wt. % proteins and cross-linked proteins as electrode binder material. This example describes the experimental procedures and results obtained for proteins such as bovine serum albumin serving as binders and processed uniquely at temperature of up to 245° C. towards the fabrication of Li-ion battery anode composed of high content of Si powder.

Briefly, the results show that the electrochemical response and behavior of Si anode in the cycled cell against Li-metal depends on the thermal processing temperature of the electrode. Increasing the thermal processing temperature leads to a more stable electrode cycling, achieving extreme reversible capacities.

Abbreviations used for this example: BSA=Bovine serum albumin; TFE=trifluoroethanol; TFA=trifluoroacetic acid; EDA=ethylenediamine.

Proteinaceous binder composition for electrode preparation: 14 wt. % BSA protein was dissolved in TFE:water (4:1) mixture overnight to afford a clear solution, followed by adding 6% 2-mercaptoethanol (disulfide bond reducing agent) into the reaction mixture and mixed well for 3-4 hours to get a cloudy solution. Thereafter 5% EDA (an organic base) diluted with ethanol (1:1) was added into the reaction mixture and mixed well to afford a clear solution. Cross-linking of BSA depends on the amino acids of the protein itself, and specifically, the formation of S—S bonds between different cysteine residues of different protein chains in the formulation.

The protein concentration was adjusted by diluting it with TFE and EDA accordingly. A 2.8 wt. % proteinaceous binder composition: 4.15 mL of protein solution was diluted with 10 mL of TFE followed by 3.5 mL of TFE:EDA (3:1) was added into the mixture and mixed well to afford a clear solution.

An exemplary anode slurry composition included:
70 wt. % Si powder;
20 wt. % carbon black;
10 wt. % cross-linked BSA (pH=8-9) with protein concentration of 100 mg in 1 ml of TFE.

Slurry (ink) preparation: 07 grams of Si powder, 0.2 grams of carbon black Super-P (TIMCAL) and 0.10 grams of the proteinaceous binder composition were dispersed in 2 mi of TFE and 0.6 ml of EDA with a mass ratio of 7:2:1 (pH about 8.5), Control slurry (control ink): 70 wt. % Si powder, 20 wt. % carbon black and 10 wt. % PVDF was used as a control slurry.

The mixtures were stirred for 24 hours using a magnetic stirrer to form a uniform slurry. The protein-based slurry was coated on the copper foil using a doctor blade method, and then dried under vacuum at 50° C., 65° C., 80° C., 100° C., 120° C., 160° C., 200° C., and 245° C. for 24 hours. The mass loading of the loading active substance was set between 1.0-3.5 mg cm⁻². The control slurry was dried at 120° C. under vacuum for 24 hours.

The electrochemical performance of the electrodes was evaluated by a T-cell half-cell, which was assembled in an Ar-filled glove box. The T-cell half-cells employed a lithium metal foil as a counter electrode, and a fiber glass filter 200 μm as a separator.

The electrolyte was a 1 M LiPF₆ in ethylene carbonate/dimethyl carbonate (EC/DMC; 1:1 by volume).

The galvanostatic discharge with 0.1 mA/cm² current density; charge was conducted by using an ARBIN Instrument Testing System at room temperature with a fixed voltage range of 0.005-1.5 V (vs Li/Li⁺) after 12 hours rest at OCV.

Si-Protein sample electrodes drying temperature was 50° C. and 65° C. The 65° C. drying temperature showed high discharging capacity (2600 mAh/g) while the 50° C. drying temperature showed smaller capacity (1300 mAh/g) in the first cycle and low discharge capacity in the second cycle (less than 250 mAh/g).

The Si-PVDF based electrode and the 50° C. drying temperature Si-Protein show similar behaviour. Overall, 65° C. process conducted with the Si-protein seems slightly better.

Table 1 below presents the charge and discharge results obtained for a Si anode vs. Li foil in a T-cell, using PVDF binder and protein binder. The Si-PVDF binder was thermally processed at 120° C. drying temperature and used as a reference control ink. The Si-Protein based electrode were dried at different drying temperatures: 80° C., 100° C., and 120° C.

TABLE 1

| # of | PVDF | | 80° C. | | 100° C. | | 120° C. | |
|---|---|---|---|---|---|---|---|---|
| cycles | Charge | Discharge | Charge | Discharge | Charge | Discharge | Charge | Discharge |
| 1 | 497.6 | 2388.3 | 297.7 | 2016.0 | 1351.7 | 2103.5 | 783.6 | 3505.6 |
| 2 | 237.8 | 390.6 | 199.3 | 298.7 | 1186.7 | 1513.8 | 349.1 | 709.4 |
| 3 | 129.3 | 186.0 | 159.751 | 205.6 | 857.3 | 1292.4 | 193.1 | 251.4 |
| 4 | 90.3 | 102.3 | 121.4 | 153.2 | 593.2 | 880.6 | 131.6 | 135.9 |
| 5 | 46.0 | 39.3 | 69.0 | 73.0 | | | 89.7 | 85.6 |

As can be seen in Table 1, for this group of electrodes studied, the 100° C. dried protein show high efficiency in the first 4 cycles.

Table 2 below presents the charge, discharge, and efficiency results obtain for a Si anode vs. Li foil in a T-cell, using PVDF binder and protein binder. The Si-Protein based electrode were dried at different drying temperatures: 120° C., 160° C., 200° C. and 245° C.

TABLE 2

| # of | 120° C. | | | 160° C. | | | 200° C. | | | 245° C. | | |
|---|---|---|---|---|---|---|---|---|---|---|---|---|
| cycles | Charge | Discharge | eff % | Charge | Discharge | eff % | Charge | Discharge | eff % | Charge | Discharge | eff % |
| 1 | 2341.7 | 3240.4 | 72.3 | 2821.4 | 3885.9 | 72.6 | 3379.1 | 4309.7 | 78.4 | 2276.7 | 3754.6 | 60.6 |
| 2 | 1913.8 | 2510.1 | 76.2 | 2613.5 | 2934.7 | 89.0 | 3162.3 | 3549.4 | 89.1 | 1327.1 | 2373.5 | 55.9 |
| 3 | 1184.4 | 1940.6 | 61.0 | 2170.8 | 2628.9 | 82.6 | 2948.0 | 3173.5 | 92.9 | 804.7 | 1312.7 | 61.3 |
| 4 | 735.3 | 1141.7 | 64.4 | 1842.8 | 2197.9 | 83.8 | 2715.1 | 2984.3 | 91.0 | 606.5 | 776.4 | 78.1 |
| 5 | 4954.0 | 676.1 | 73.2 | 1563.5 | 1860.0 | 84.1 | 2481.2 | 2786.2 | 89.0 | | | |

As can be seen in Table 2, the 200° C. dried protein showed high efficiency in the first cycle (78%).

### Example 2

### Proof of Concept—Egg White

Anode: 70 wt. % Si powder, 20 wt. % carbon black and 10 wt. % albumin powder (egg white) as a binder. The protein solution contained 10 wt. % albumin powder (egg white) in (1) water, (2) NMP and (3) TFE:EDA (pH=8-9).

To prepare the slurry, 0.7 grams of Si powder, 0.2 grams of carbon black (super P) and 0.10 grams of the protein solution, at a mass ratio of 7:2:1. The mixture was stirred for 24 hours using a magnetic stir to form a uniform ink slurry.

The slurry was coated on copper foil using a doctor blade method, and then dried under vacuum at 200° C. for 24 hours. The mass loading of the loading active substance was controlled at 1.0-1.5 mg cm⁻².

The electrochemical performance of the prepared silicon electrode was evaluated by a T-cell half-cell, assembled in an Ar-filled glove box.

The T-cell half-cells employ a metal lithium sheet as a counter electrode, and a fiber glass filter 200 μm as a separator, 1 M LiPF₆ in a mixture of ethylene carbonate/dimethyl carbonate (EC/DMC; 1:1 by volume) served as the electrolyte. The galvanostatic discharge with 0.1 mA/cm² current density-charge was conducted by using an ARBIN Instrument Testing System at room temperature with a fixed voltage range of 0.005-1.5 V (vs Li/Li⁺) after 12 hours at open circuit voltage (OCV).

Analysis of the charge/discharge curves of Si anode vs. Li foil in a T-cell showed 59% efficiency for the water (1) sample, 54% for the NMP (2) sample, and 68% TFE:EDA (3) sample, demonstrating high efficiency and good adhesion to the copper foil for the TFE:EDA.

### Example 3

### Proof of Concept—Casein (Protein)

Unlike the BSA, which was selected for its natural amino acids composition that is conducive for cross-linking, casein had to be modified for both cross-linking and to improve its conductivity. The chemical modification of casein involved sulfonation of some amino acids, which is a common chemical modification for synthetic conductive polymers in order to increase their ionic transport capabilities. Even though chemical modification complicates its use as a binder, casein is still advantageous due to its very low price compared to BSA.

Casein was dissolved in room temperature conditions overnight in a mixture of TFA:TFE (1:3) in a final concentration of 10 wt. % until a clear pinkish color was obtained. To this solution, 3 wt. % glycerol plasticizer was added from a stock solution of 33 wt. % glycerol in ethanol, and the solution was stirred for about 10 min at room temperature. Later, 10 vol. % mixture of chlourosulfonic acid:pyridine:ethanol (6:3:2) was added to the plasticized mixture in an ice bath to sulfonate the casein structure. Finally, glutaraldehyde was added as the cross-linker in different ratios (5-10 wt. %) under stirring for 2-3 minutes.

Anode: 70% Si powder, 20% Carbon black, 10% CAS Protein/TFE and TFA (3:1) CAS-B without cross-linker, CAS-C with cross-linker

The slurry was coated on copper foil using a doctor blade method, and then dried under vacuum at 120° C., 200° C. for 24 hours. The mass loading of the loading active substance was controlled at 1.0-1.5 mg cm⁻².

Table 3 below presents the charge, discharge, and efficiency results obtain for a Si anode vs. Li foil in a T-cell. The Si-Protein based electrode were dried at 120° C. and 200° C., without cross linker (CAS-B) and with cross-linker (CAS-C).

TABLE 3

| # of | CAS-C-200 C. | | | CAS-C-1200 C. | | | CAS-B-2000 C. | | |
|---|---|---|---|---|---|---|---|---|---|
| cycles | Charge | Discharge | eff % | Charge | Discharge | eff % | Charge | Discharge | eff % |
| 1 | 2651.4 | 3834.6 | 69.1 | 492.7 | 2849.6 | 17.3 | 1943.3 | 43854.0 | 44.3 |
| 2 | 2254.0 | 2590.0 | 87.0 | 271.8 | 354.0 | 76.8 | 1648.6 | 2200.6 | 74.9 |
| 3 | 1917.9 | 2187.3 | 87.7 | 202.9 | 224.2 | 90.5 | 1397.6 | 1794.7 | 77.9 |
| 4 | 1610.4 | 1846.9 | 87.2 | 162.3 | 166.7 | 97.4 | 1198.1 | 1476.8 | 81.1 |
| 5 | 1311.5 | 1545.5 | 84.9 | 115.7 | 111.6 | 103.6 | 1048.7 | 1240.3 | 84.6 |

As can be seen in Table 3, the CAS-C protein-based anode, dried at 200° C., exhibited high efficiency in the first cycle (69%).

The results obtained with casein-based binder formulation are less impressive than those obtained with BSA protein, presumably due to two inherent features of this specific protein: 1) casein contains more hydrophobic amino acid residues that are poor ionic conductors; and 2) casein does not have a helical secondary structure that adversely affect elastic properties of the resulting thermally treated bonder layer.

### Example 4

### FTIR and WAXS Analysis

The chemical footprint of the protein-based ink slurry formulation was characterized following baking at different temperatures, using FTIR and wide-angle X-ray scattering (WAXS). The native protein solution was tested first, followed by examining the final binder formulation for making the anode, i.e., the protein binder with the Si and the carbon black.

In the temperature-dependent FTIR and WAXS measurements of the native protein solution, there was no significant difference in the chemical fingerprint of the protein upon baking. The “amide I peak” at 1700-1600 cm⁻¹ and the “amide II peak” at 1600-1500 cm⁻¹ wavelengths remained roughly the same with only the broad band around 3300 cm⁻¹ being affected by baking, which corresponds to trapped water molecules that evaporated during baking. In the WAXS measurements, the characteristic diffraction peaks at 8.7 and 19.5, which correspond to the interatomic distances in the protein and periodic distance between protein chains, did not change significantly, though the peak at 19.5 became marginally sharper, indicating some thermally induced changes in the crystallinity of the protein film.

On the other hand, the FTIR spectra of the full binder composition (the protein+Si+CB) showed a significant difference upon baking. As in the native protein sample, at a lower temperature, the FTIR spectra of the anode clearly showed the amide I and amid II signals at 1521 and 1641 cm¹, respectively; however, at higher temperatures, the signals of the amide I and amide II bands disappear due to heat-induced partial degradation. The observed broad peak at 1032 cm⁻¹ was from the ═C═O stretching of the carbon-black-COOH. With increasing temperature, the signals disappeared due to degradation of the protein functional groups as a function of temperature interacting with the components of the binder. At 200° C. a peak at 1012 cm⁻¹ appeared, which was not observed at low temperatures, and this band was attributed to Si—O—Si stretching. Initially, Si particles were masked by the BSA coating; however, at higher temperatures, they were exposed because of the shrinking of the protein layer induced by solvent loss and partial degradation.

### Example 5

### Protein Vs. Carboxymethyl Cellulose (CMC)

Based on the promising preliminary results of the protein-binder versus PVDF-binder, the inventors conducted an additional comparison with the commercial state-of-the-art polysaccharide-based binder, namely sodium carboxymethyl cellulose (CMC), which is typically used in combination with the synthetic polymer—styrene butadiene rubber (SBR). Although the first cycle performance of CMC-based binder was superior to that of the PVDF-binder, the BSA-based binder nevertheless remained unsurpassed.

The cycling performance of Si-BSA versus Si-PVDF and Si-CMC reference electrodes was studied in 100 cycles trial accomplished at 1 mA/cm² current density (about 0.1C rate) in the potential window of 0.005-1.5 V. For this trial, the electrodes were dried at optimal temperatures, i.e., Si-BSA at 200° C., Si-PVDF at 120° C., and Si-CMC at 160° C.

As observed, while the charge capacity of Si-PVDF and Si-CMC anodes dropped down below 200 mAhg-1 level already after six initial cycles, the Si-BSA anode showed gradual capacity decline reaching 500 mAhg-1 only at the 100^{th} cycle. Therefore, it is considered proven that the cycling performance of Si-BSA anode is essentially more stable as compared to that of Si-PVDF and Si-CMC anodes.

Finally, the effect of slurry drying temperature in the range of 120-245° C. on the cycling performance of Si-BSA anodes was studied at the same conditions, and the results clearly showed that the anode dried at 200° C. demonstrates the best comparative cyclability. It was observed experimentally that the higher the drying temperature was applied, the higher was the electrode potential at which the electroreduction process of interest commences, and the greater was the overall energy impact. This drying/baking temperature effect is attributed, without being bound to any particular theory, to irreversible electroreduction of the Si—O—Si groups, which are formed in the composite anode upon drying in vacuum at temperatures above 160° C. Indeed, the FTIR measurements of Si-BSA anode showed peak at 1012 cm-1 appeared, which was not observed at low temperatures, and this band was due to Si—O—Si stretching. Apparently, the same phenomenon was also observed with Si-CMC anode dried at 200° C. The absence of such effect in the case of Si-PVDF anode is attributed to lack of water, which inevitably presents in sufficient quantity in the bound state in BSA polymer and as a solvent in the CMC-SBR binder. It is assumed that water can interact with Si particles forming Si—O—Si groups upon long (e.g., 24 hours) thermal treatment.

### Example 6

### Practical Empiric Conclusions

An effective binder composition in electrodes is required to be elastic material that can envelope the Si particles and still support their swelling and deswelling cycles. While proteins are elastic to some extent, there is still a need to modify the proteinaceous substance and render it a protein-based polymer that can envelope Si particles consistently under charge/recharge cycles. The elasticity of protein-based polymers is related to the original structure of the source proteins, hence, although the native structure is being destroyed (denaturation) even before the thermal treatment, some remnants and properties of the secondary structure are attributed to the elasticity of the proteinaceous layer that is afforded after heating. While the secondary structure contributes to the elasticity of the binder, the primary structure, namely the chemical nature of the side chains of the polypeptide chain, are associated with the electrical conductivity of the proteinaceous substance, as certain side chain function groups are more conducive to and assist in ion migration; typically charged and/or polar amino acid residues.

The slurry preparation protocol has been systematically optimized to improve its rheological properties and the adhesion between the composite anode and the Cu current collector. Such optimization included: optimizing the binder/solvent/pH stabilizer ratio, introducing the ball milling as a slurry homogenization process, adding surfactant, pretreatment with 0.5% nitric acid to improve the adhesion to copper surface.

Moreover, it is proposed to incorporate the process of protein crosslinking into the composite electrode fabrication. In other words, combine the protein dissolution in the organic solvent mixture with the crosslinking and slurry homogenization processes.

Four proteins were tested, namely, BSA, casein (the primary protein component in dairy products), zein (a prolamin, which is a type of storage protein) and soy protein. The Si-BSA composite electrodes demonstrated significantly improved electrochemical performance and stability in half-cells versus other Si-protein electrodes as well as versus the reference electrodes (Si-PVDF and Si-CMC). The Si-casein electrode's performance was also superior to that of the Si-PVDF and Si-CMC reference electrodes.

The optimal thermal treatment (drying/baking temperature) for BSA-based and casein-based binders was found to be 200° C. It was found that the thermal treatment at such temperature effectively removes the water, while the protein's secondary structure, presumably contributing advantageously to the binders' mechanical and electrochemical properties, remains essentially intact. Yet, trace amount of water interacts with Si particles upon long (e.g., 24 hours) thermal treatment forming Si—O—Si groups, as corroborated by FTIR analysis, which further electro-reduced in half-cell during the first discharging process.

It was established that the optimal mass loading for the applied composite Si-anode formulation (10 wt. % proteinaceous binder composition, 20 wt. % carbon powder, and 70 wt. % Si powder) is about 1.65 mg/cm², nevertheless further optimizing was carried out at a fixed mass loading of 3.0 mg/cm², which is dictated by the requirements and standards of modern industrial battery manufacturing.

It was found that the most suitable solvent for BSA-based binder is TFE:water. EDA was found to be an effective cross-linking agent. The half-cells assembled from the composite anodes containing cross-linked BSA in the binder composition showed the maximal CE. Moreover, using TFE:water solvent seemed to improve adhesion between the thermally treated layer and the Cu current collector.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claims is:

1. A slurry for preparing an electrode, comprising:
an active material;
a conductive additive; and
a binder composition,
wherein said binder composition comprises a proteinaceous substance, said proteinaceous substance comprises at least one amino acid, and/or at least one peptide, and/or at least one protein.

2. The slurry of claim 1, wherein said proteinaceous substance is at least partially denatured.

3. The slurry of claim 1, wherein said proteinaceous substance is cross-linked.

4. The slurry of claim 1, wherein said proteinaceous substance is characterized by at least one of:
commercial availability in large amounts;
low cost;
non-toxicity;
environmentally friendly manufacturing process;
water solubility greater than 10 mg/ml; and
hydropathy index greater than 0.5.

5. The slurry of claim 1, wherein said proteinaceous substance is chemically modified.

6. The slurry of claim 5, wherein said chemical modification is selected from the group consisting of cross-linking, sulfonation, and hydrolysis.

7. The slurry of claim 1, wherein said binder composition comprises a reagent selected from the group consisting of trifluoroethanol, trifluoroacetic acid, ethylenediamine and any combination thereof.

8. The slurry of claim 1, wherein:
an amount of said active material ranges 50-95 wt. % of the slurry;
an amount of said conductive additive ranges 5-30 wt. % of the slurry; and
an amount of said binder composition ranges 5-20 wt. % of the slurry.

9. The slurry of claim 1, wherein an amount of said proteinaceous substance in said binder composition ranges 1-15 wt. % of said binder composition.

10. An electrode comprising:
a current collector; and
a thermally treated layer of the slurry of claim 1, applied on a surface of said current collector.

11. A battery comprising the electrode of claim 10.

12. A process of preparing the electrode of claim 10, comprising:
applying said slurry on said surface;
heating said slurry on said surface to a temperature of more than 120° C., thereby obtaining said thermally treated layer.

13. The process of claim 12, wherein said temperature ranges 120-300° C.

14. The process of claim 13, wherein said temperature ranges 200-250° C.

15. An electrode comprising:
a current collector; and
a layer of a slurry applied on a surface of said current collector, wherein said slurry comprises:
an active material;
a conductive additive; and
a binder composition,
wherein said binder composition comprises a proteinaceous substance, said proteinaceous substance comprises at least one amino acid, and/or at least one peptide, and/or at least one protein;
said proteinaceous substance is at least partially denatured; and
said proteinaceous substance is cross-linked.

16. A battery comprising the electrode of claim 15.

17. An electrode comprising:
a current collector and a layer that comprises an active material, a conductive additive and a binder composition applied thereon,
wherein said binder composition comprises a proteinaceous substance, said proteinaceous substance comprises at least one amino acid, and/or at least one peptide, and/or at least one protein.

18. A battery comprising the electrode of claim 17.
